(19) United States
(12) Patent Application Publication
(10) Pub. No.: US 2004/0248562 A1
(43) Pub. Date: Dec. 9, 2004

(54) Apparatus and method for remotely changing a function of a mobile communcation terminal

(75) Inventor: Yong-Sik Kim, Gyeonggi-Do (KR)

Correspondence Address: JONATHAN Y. KANG, ESQ., LEE & HONG P.C., 14th Floor, 801 S. Figueroa Street, Los Angeles, CA, 90017-5554, US

(73) Assignee: LG Electronics Inc.

(21) Appl. No.: 10/861,649

(22) Filed: Jun. 3, 2004

(30) Foreign Application Priority Data
Jun. 4, 2003 (KR) 2003-35866

(51) Int. Cl. H04M 11/00

(52) U.S. Cl. 455/414.4; 455/418

(57) ABSTRACT

A system, apparatus and method for remotely changing a specific function of a mobile communication terminal are disclosed. Function Change information having a specific format is generated in response to a function change request and the function change information is inserted in a control message sent to a terminal. The terminal receives the control message, extracts the function change information and changes an indicated specific function according to the function change information. Remotely changing a specific function of a terminal with little inconvenience to a user is facilitated.

### CROSS-REFERENCE TO RELATED APPLICATIONS

Pursuant to 35 U.S.C. § 119(a), this application claims the benefit of earlier filing date and right of priority to Korean Application No. 35866/2003, filed on Jun. 4, 2003, 2003, the contents of which is hereby incorporated by reference herein in their entirety:

### BACKGROUND OF THE INVENTION

1. Field of the Invention

The present invention relates to a mobile communication system and, more particularly, to a system, apparatus and method for remotely changing a specific function of a mobile communication terminal.

2. Description of the Related Art

Wireless data communication refers to a user of a mobile communication terminal sending and receiving data such as text, numerals, or images. A mobile communication system refers to a system allowing a user to exchange and search data bi-directionally with a terminal such as a cellular phone, a portable computer, a facsimile machine or a credit card.

Mobile communication terminals have evolved from the cellular phone developed in the early 1980s to products having diverse functions. Mobile communication terminals now provide diverse services such as text messaging, electronic mail, and Internet access as well as traditional voice call communication.

Text message service provided by a mobile communication service provider is classified according to a type and size of transmitted data. For example, a short message service (SMS) allows transmitting text data up to 80 bytes, a long message service (LMS) allows transmitting text data up to 400 bytes, and a multimedia message service (MMS) allows transmitting multimedia data.

FIG. 1 illustrates the construction of a related art mobile communication system for the SMS service. The mobile communication system 1 includes a base station system 12, a plurality of mobile communication terminals 10, 11, an SMS server 13 connected to the base station system, and an LMS server 14 connected to the base station system. The base station system 12 includes a base station/base station controller (BSC/BTS) 16, a home location register (HLR) (not shown), and a mobile switching center (MSC) 18.

The base station system 12 processes a function signal, such as a call signal or SMS signal transmitted between terminals 10, 11. The SMS server 13 provides an SMS account for each terminal 10, 11. The LMS server 14 provides an LMS account for each terminal 10, 11.

When a user of terminal 10 inputs SMS data intended for terminal 11, terminal 10 inserts the SMS data into a data burst message and transmits the SMS data to the base station system 12. The base station system 12 transfers the received SMS data to the SMS server 13.

Once the SMS data is received, the SMS server 13 informs terminal 11 of reception of the SMS data via the base station system unit 12. If the user of terminal 11 desires to receive the SMS data, the SMS server 13 transmits the SMS data to terminal 11. If the user of terminal 10 transmits large-capacity LMS data intended for terminal 11, the base station system 12 manages the LMS data with the LMS server 14 and transmits the LMS data to terminal 11.

Supporting multiple-language SMS or LMS transmissions in a mobile communication terminal 10, 11 is very burdensome and requires a great amount of time and effort by the terminal developer. Presently, many mobile communication terminals 10, 11 support only two languages.

If a different language is required to support the text message service transmission needs of a particular user, the existing software of the terminal 10, 11 must be modified or new software downloaded to the terminal. If a detailed item of a specific function installed in the terminal 10, 11 needs to be changed, the user may have to visit a service firm personally. The inconvenience to a user is great.

Therefore, there is a need to facilitate easily changing a specific function of a mobile communication terminal, such as the supported language, with little inconvenience to the user. The present invention addresses this and other needs.

### SUMMARY OF THE INVENTION

An object of the present invention is to provide a system, apparatus and method for remotely changing a specific function of a mobile communication terminal. To achieve these and other objects and in accordance with the purpose of the present invention, as embodied and broadly described herein, there is provided a system, apparatus and method for remotely controlling a mobile communication terminal to change a specific function of the terminal via wireless communication.

In one aspect of the invention, a wireless communications system is provided to facilitate remote control of a terminal in a mobile communication system. The system includes a control unit, a message unit, and at least one terminal.

The control unit receives a function change request to change a specific function of a terminal in the system and generates function change information having a specific format to effect the change. The function change information indicates the requested change to the specific function of the terminal.

A terminal requesting a specific function change may send the function change request. Alternately a base station network of which the control unit is a part may send the function change request or the function change request may be received over the Internet via a personal computer to which the control unit is connected. In a preferred embodiment, the control unit is a control server and the function change information is in an SMI (Structure of Management Information) format.

It is contemplated that the specific function may be any function, for example the language, color or font of information displayed by the terminal. It is further contemplated that an entire function, such as the language of text stored in the memory of a terminal, or only a portion of a function, such as the language of specific displayed words, may be changed.

The message unit receives the function change information from the control unit and transmits the function change information to a terminal as part of a control message. In a preferred embodiment, the message unit is an LMS server and the control message is part of an LMS message. It is contemplated that the control message containing the function change information may be transmitted to a plurality of terminals in order to facilitate changing the same specific function in each terminal.

The terminal receives a control message containing the function change information. The terminal extracts the function change information from the control message and changes the specific function according to the function change information.

In another aspect of the invention, an apparatus is provided to facilitate remote control of a terminal in a mobile communication system. The apparatus includes a control server and an LMS server.

The control server receives a function change request to change a specific function of a terminal in the mobile communication system and generates function change information having a specific format to effect the change. The function change information indicates the requested change to the specific function of the terminal.

A terminal requesting a specific function change may send the function change request. Alternately, a base station network of which the control unit is a part may send the function change request or the function change request may be received over the Internet via a personal computer to which the control unit is connected.

It is contemplated that the specific function may be any function, for example the language, color or font of information displayed by the terminal. It is further contemplated that an entire function, such as the language of text stored in the memory of a terminal, or only a portion of a function, such as the language of specific words on the display, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the control unit is a control server and the function change information is in an SMI format.

The LMS server receives the function change information from the control server and transmits the function change information to the terminal as part of an LMS message. It is contemplated that the LMS message containing the function change information may be transmitted to a plurality of terminals in order to facilitate changing the same specific function in each terminal.

In another aspect of the invention, a terminal is provided to facilitate remote control of a function in a mobile communication system. The terminal includes a transmitting unit, a display unit, a storage unit, a receiving unit, and a processing unit.

The receiving unit receives a control message containing function change information having a specific format. The function change information indicates changing a specific function of the terminal.

It is contemplated that the specific function may be any function, for example the language, color or font of information displayed by the display unit as well as the language of information stored in the storage unit. It is further contemplated that an entire function, such as the language of text stored in the storage unit, or only a portion of a function, such as the language of specific words on the display unit, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

The processing unit extracts the function change information from the control message and changes the specific function of the terminal according to the function change information. In a preferred embodiment, the control message is part of an LMS message.

The transmitting unit facilitates communication with other components of the mobile communication system. The transmitting unit may also facilitate sending a function change request, preferably over a control channel, to request a specific function change.

In another aspect of the invention, a first method is provided to facilitate remote control of a terminal in a mobile communication system. The first method includes receiving a function change request related to a specific function of a terminal, forming function change information in a specific format, generating a control message containing the function change information, and transmitting the control message to a terminal.

A terminal requesting a specific function change may send the function change request. Alternately, a base station network of which the control unit is a part may send the function change request or the function change request may be received over the Internet via a personal computer to which the control unit is connected.

It is contemplated that the specific function may be any function, for example the language, color or font of information displayed by the terminal. It is further contemplated that an entire function, such as the language of text stored in the memory of a terminal, or only a portion of a function, such as the language of specific words on the display, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

In a preferred embodiment, the control message is part of an LMS message. It is contemplated that the control message containing the function change information may be transmitted to a plurality of terminals in order to facilitate changing the same specific function in each terminal.

In another aspect of the invention, a second method is provided to facilitate remote control of a terminal in a mobile communication system. The second method includes determining that a received message is a specific type, determining that the received message contains function change information, extracting function change information from the message, and changing a specific function of the terminal according to the function change information.

In a preferred embodiment, the specific type of message is an LMS message and the presence of an SMI format indicates that the LMS message contains function change information. It is contemplated that the specific function may be any function, for example the language, color or font of information displayed by the terminal. It is further contemplated that an entire function, such as the language of text stored in the memory of a terminal, or only a portion of a function, such as the language of specific displayed words, may be changed.

The function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a block diagram of a mobile communication system for an SMS service in the related art.

FIG. 2 illustrates a block diagram of a wireless communication system for remote control of a terminal in accordance with one embodiment of the present invention.

FIG. 3 illustrates a block diagram of a terminal for remote control of a function in a mobile communication system in accordance with one embodiment of the present invention.

FIG. 4 illustrates a flow chart of a method for remote control of a terminal in a mobile communication system in accordance with one embodiment of the present invention.

FIG. 5 illustrates a flow chart of a method for remote control of a terminal in a mobile communication system in accordance with another embodiment of the present invention.

FIG. 6 illustrates an LMS message containing function change information in an SMI format in accordance with one embodiment of the present invention.

FIG. 7 illustrates changing a language function of a terminal in a mobile communication system in accordance with a method of the present invention.

### DETAILED DESCRIPTION OF THE PREFERRED EMBODIMENTS

The present invention relates to a system, apparatus and method for remotely controlling a mobile communication terminal to change a specific function of the terminal via wireless communication. Although the present invention is illustrated with respect to changing a specific function related to text communication, it is contemplated that the present invention may be utilized anytime it is desired to remotely control a terminal in a mobile communication system.

The present invention proposes a system, apparatus and method for remotely controlling a mobile communication terminal to change a specific function of the terminal. A control message containing information related to the specific function is sent to a terminal in response to a change request. The terminal receives the control message, extracts the information related to the specific function, and changes the specific function.

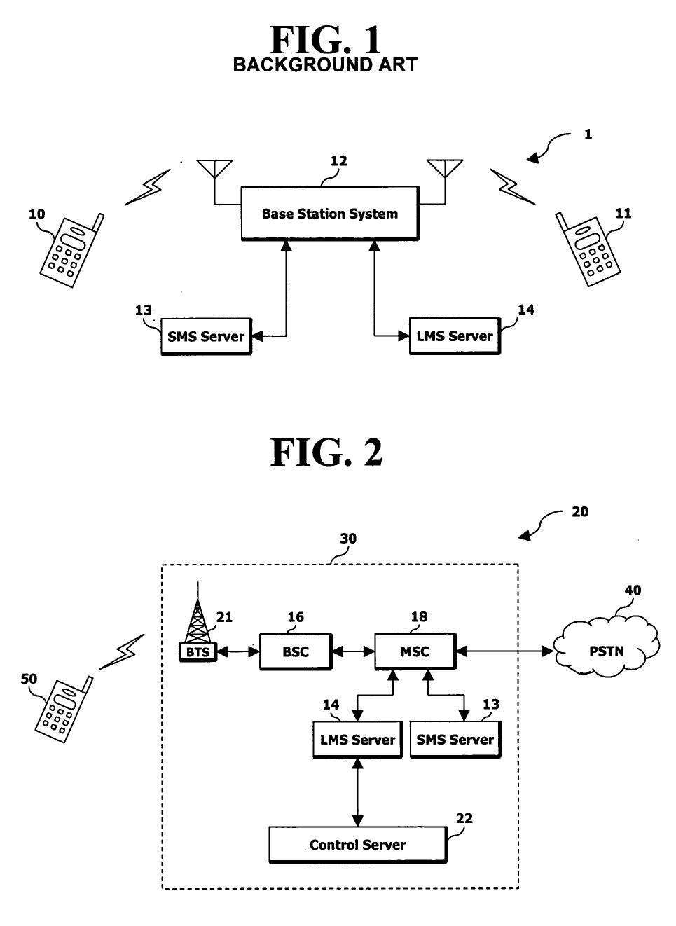

FIG. 2 illustrates a wireless communication system 20 to facilitate remote control of a terminal in a mobile communication system. The system 20 includes a control unit 22, a message unit 14, and at least one terminal 50. The control unit 22 and message unit 14 may be part of a base station network 30 which includes a base station transceiver subsystem (BTS) 21, a base station controller (BSC) 16, a mobile switching center (MSC) 18 and an SMS server 13.

The control unit 22 receives a function change request to change a specific function of a terminal 50 in the system 20 and generates function change information having a specific format to effect the change. The function change information indicates the requested change to the specific function of the terminal 50.

A terminal 50 requesting a specific function change may send the function change request. A function change request sent by a terminal 50 is preferably sent over a control channel. Alternately, a base station network 30 of which the control unit is a part may send the function change request or the function change request may be received over the Internet from a PSTN (Public Switched Telephone Network) 40 via a personal computer (not shown) to which the control unit is connected.

The specific function may be any function, for example the language, color or font of information displayed by the terminal. Furthermore, an entire function, such as the language of text stored in the memory of a terminal 50, or only a portion of a function, such as the language of specific displayed words, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the control unit 22 is a control server and the function change information is in an SMI format.

The message unit 14 receives the function change information from the control unit 22 and transmits the function change information to a terminal 50 as part of a control message, preferably via the BSC 16 and the BTS 21. In a preferred embodiment, the message unit 14 is an LMS server and the control message is part of an LMS message. If it is desired to change the same specific function in more than one terminal 50, the control message containing the function change information may be transmitted to a plurality of terminals.

The terminal 50 receives a control message containing the function change information and analyzes the format. The terminal extracts the function change information from the control message and changes the specific function according to the function change information.

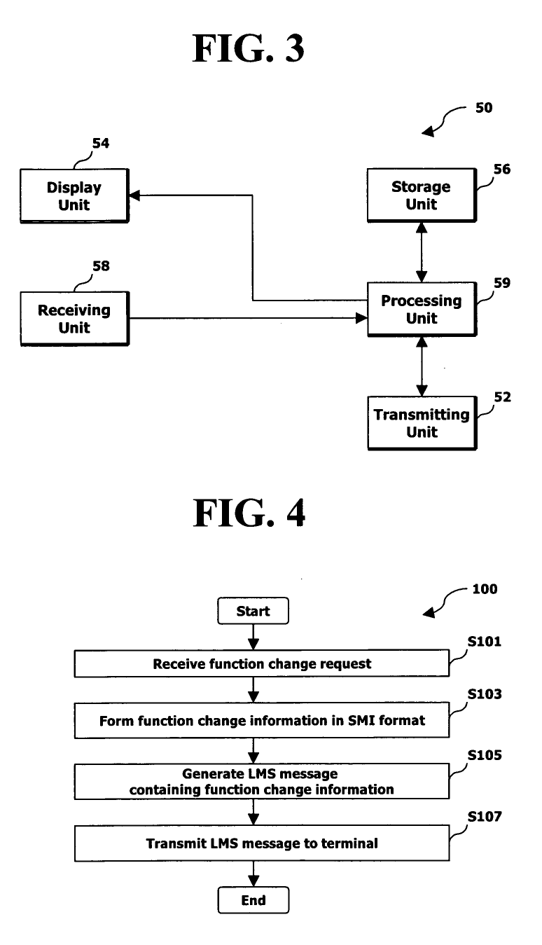

FIG. 3 illustrates a terminal 50 to facilitate remote control in a mobile communication system. The terminal 50 includes a transmitting unit 52, a display unit 54, a storage unit 56, a receiving unit 58, and a processing unit 59.

The receiving unit 58 receives a control message containing function change information having a specific format. The function change information indicates changing a specific function of the terminal 50.

It is contemplated that the specific function may be any function, for example the language, color or font of information displayed by the display unit 54 as well as the language of information stored in the storage unit 56. It is further contemplated that an entire function, such as the language of text stored in the storage unit 56, or only a portion of a function, such as the language of specific words on the display unit 54, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

The processing unit 59 extracts the function change information from the control message and changes the specific function of the terminal 50 according to the function change information. In a preferred embodiment, the control message is part of an LMS message.

The transmitting unit 52 facilitates communication with other components of the mobile communication system. The transmitting unit 52 may also facilitate sending a function change request, preferably over a control channel, to request a specific function change for the terminal 50.

FIG. 4 illustrates a first method 100 to facilitate remote control of a terminal in a mobile communication system. The method 100 includes the steps of receiving a function change request related to a specific function of a terminal S101, forming function change information in a specific format S103, generating a control message containing the function change information S105, and transmitting the control message to a terminal S107.

In step S101, a function change request to change a specific function of a terminal 50 is received. A terminal 50 requesting a specific function change may send the function change request. Alternately, a base station network 30 of which the control unit is a part may send the function change request or the function change request may be received over the Internet from a PSTN 54.

In step S103, function change information is formed based on the received function change request. The function change information is in a specific format, preferable SMI. The function change information indicates changing a specific function of the terminal 50.

The specific function may be any function, for example the language, color or font of information displayed by the terminal 50. Furthermore, an entire function, such as the language of text stored in the memory of a terminal 50, or only a portion of a function, such as the language of specific words on the display, may be changed.

The specific format of the function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

In step S105, a control message containing the function change information is generated. In a preferred embodiment, the control message is part of an LMS message.

In step S107, the control message containing the function change information is transmitted to a terminal 50. The control message may be transmitted to a plurality of terminals in order to facilitate changing the same specific function in each terminal.

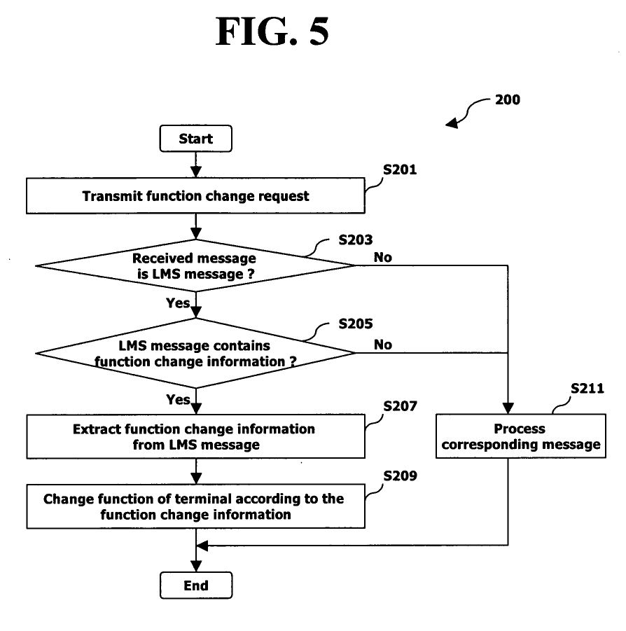

FIG. 5 illustrates a second method 200 to facilitate remote control of a terminal in a mobile communication system. The method 200 includes the steps of determining that a received message is a specific type S203, determining that the received message contains function change information S205, extracting function change information from the message S207, and changing a specific function of the terminal according to the function change information S209. The method may also include the step of transmitting a function change request S201.

If a terminal requests a specific function change, a function change request is transmitted in step S201. The function change request is preferably transmitted over a control channel.

In step S203, a message is received and it is determined whether the message is a specific type. In a preferred embodiment, it is determined whether the received message is an LMS message.

If the received message is not the specific type, the message is processed according to a set procedure in step S211. If the received message is the specific type, it is determined whether the message contains function change information in step S205. In a preferred embodiment, whether the message contains function change information is determined by checking for an SMI format.

If the received message does not contain function change information, the message is processed according to a set procedure in step S211. If, the received message contains function change information, the function change information is extracted from the message in step 207 and the specific function of the terminal 50 is changed according to the function change information in step 209.

The specific function may be any function, for example the language, color or font of information displayed by the terminal. Furthermore, an entire function, such as the language of text stored in the memory of a terminal, or only a portion of a function, such as the language of specific displayed words, may be changed.

The function change information may include an index and a change variable, the index indicating a portion of a specific function and the change variable indicating the manner in which the portion of the specific function is changed. For example, if the specific function is the language of displayed text, the index may indicate specific words and the change variable may indicate the language in which to display the specific words. In a preferred embodiment, the function change information is in an SMI format.

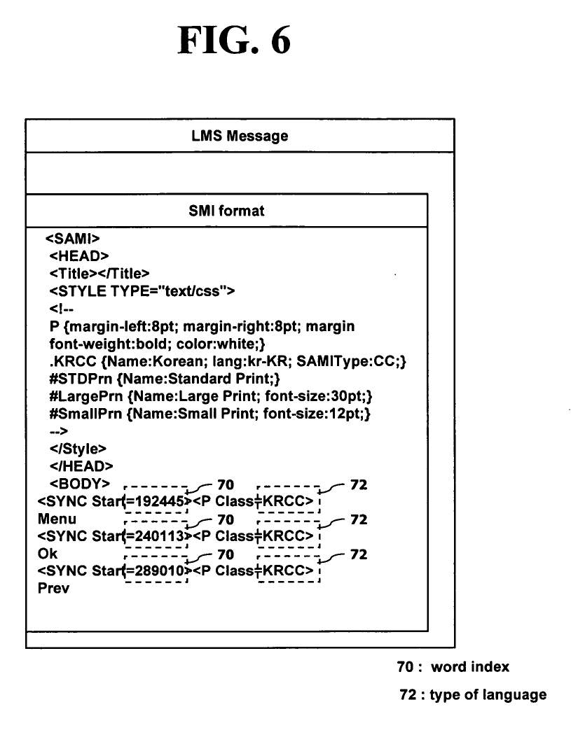

FIG. 6 illustrates an LMS message containing function change information in an SMI format. As illustrated, the SMI format includes an index 70 and a change variable 72. The index 70 may indicate an item of a word index to be changed and the change variable 72 may indicate a language to which the indicated word is changed.

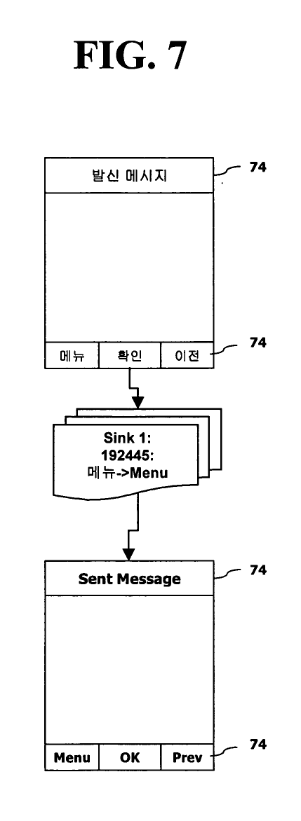

Referring again to the example illustrated in FIG. 6, if the indexes 70 (192445, 240113, 289010) of the SMI format of the LMS message indicate specific words displayed by a window 74 of the terminal display and the change variables 72 (KRCC) indicate a change from Korean to English, the language of the specified words is changed from Korean to English as illustrated in FIG. 7. The specific function of the terminal 50, namely the language of specific displayed words, is changed from the Korean language to the English language according to the function change information included in the LMS message.

Utilizing the system, apparatus and methods of the present invention, not only may the language of specific displayed words in a terminal be changed, but an entire stored language support function can be easily and remotely changed if a terminal originally produced for domestic use is be sold for use in other countries.

Although changing only a language function of a single terminal has been illustrated with regard to the system, apparatus and methods herein, it is obvious the present invention may be also applied to a plurality of terminals when the same function change is desired in each of the plurality of terminals. Furthermore, the present invention may also be utilized to change other functions of a terminal, such as the color and font of displayed text.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A wireless communication system for remote control of a terminal in a mobile communication system, the system comprising:
a control unit adapted to receive a function change request to change a specific function of at least one terminal and generate function change information in a specific format;
a message unit adapted to receive the function change information from the control unit and transmit the function change information to the at least one terminal as part of a control message; and
at least one terminal adapted to receive the control message and change the specific function according to the function change information included in the control message.

2. The system of claim 1, wherein the message unit is an LMS (Long Message Service) server and the control message is part of an LMS message.

3. The system of claim 1, wherein the control unit is a control server.

4. The system of claim 1, wherein the function change request is received from the Internet.

5. The system of claim 4, wherein the control unit is connected to a personal computer (PC).

6. The system of claim 1, wherein the function change request is received from a terminal.

7. The system of claim 1, wherein the function change request is received from a base station network that is a part of the mobile communication system.

8. The system of claim 1, wherein the function change information causes the at least one terminal to change an entire specific function.

9. The system of claim 1, wherein the function change information causes the at least one terminal to change a portion of the specific function.

10. The system of claim 1, wherein the specific format is an SMI format.

11. The system of claim 1, wherein the message unit transmits the function change information to a plurality of terminals, each terminal adapted change a specific function according to the function change information.

12. An apparatus for remote control of a terminal in a mobile communication system, the apparatus comprising:
a control server adapted to receive a function change request to change a specific function of at least one terminal and generate function change information in a specific format; and
an LMS (Long Message Service) server adapted to receive the function change information from the control server and transmit the function change information to the at least one terminal as part of an LMS message.

13. The apparatus of claim 12, wherein the function change request is received from the Internet.

14. The apparatus of claim 13, wherein the control server is connected to a personal computer (PC).

15. The apparatus of claim 12, wherein the function change request is received from a terminal through a control channel.

16. The apparatus of claim 12, wherein the function change request is received from a base station network that is part of the mobile communication system.

17. The apparatus of claim 12, wherein the function change information indicates changing an entire specific function.

18. The apparatus of claim 12, wherein the function change information indicates changing a portion of a specific function.

19. The apparatus of claim 12, wherein the specific function is one of a language, a color and a font.

20. The apparatus of claim 19, wherein the specific format comprises an index and a change variable, the index indicating a portion of a specific function and the change variable indicating a manner in which to change the portion of the specific function.

21. The apparatus of claim 20, wherein the specific function is a language displayed by the display unit, the index indicates a displayed word and the change variable indicates a new language.

22. The apparatus of claim 12, wherein the specific format is an SMI format.

23. The apparatus of claim 12, wherein the LMS server transmits the function change information to a plurality of terminals.

24. A terminal for remote control of a function in a mobile communication system, the terminal comprising:
a transmitting unit adapted to communicate with a network system;
a display unit adapted to convey information to a user;
a storage unit adapted to store information;
a receiving unit adapted to receive a control message containing function change information in a specific format; and
a processing unit adapted to extract the function change information from the control message and change a specific function according to the function change information.

25. The terminal of claim 24, wherein the transmitting unit is further adapted to transmit, over a control channel, a function change request to change a specific function of the terminal.

26. The terminal of claim 24, wherein the control message is part of an LMS (Long Message Service) message.

27. The terminal of claim 24, wherein the processing unit changes an entire specific function according to the function change information.

28. The terminal of claim 24, wherein the processing unit changes a portion of a specific function according to the function change information.

29. The terminal of claim 24, wherein the specific format is an SMI format.

30. The terminal of claim 24, wherein the specific function is one of a language displayed by the display unit, a language stored in the storage unit, a color displayed by the display unit and a font displayed by the display unit.

31. The terminal of claim 30, the specific format including an index and a change variable and wherein the processing unit is adapted to change a portion of the specific function corresponding to the index in a manner based on the change variable.

32. The terminal of claim 31, wherein the specific function is the language displayed by the display unit, the index is a start position and the change variable is a new language, and the processing unit is adapted to change the language of specific words corresponding to the start position to the new language.

33. A method for remote control of a terminal in a mobile communication system, the method comprising the steps of:
receiving a function change request to change a specific function of at least one terminal;
forming function change information in a specific format;
generating a control message containing the function change information; and
transmitting the control message to the at least one terminal.

34. The method of claim 33, wherein the control message is part of an LMS (Long Message Service) message.

35. The method of claim 33, wherein the function change request is received from the Internet.

36. The method of claim 33, wherein the function change request is received from a terminal over a control channel.

37. The method of claim 33, wherein the function change request is received from a base station network that is part of the mobile communication system.

38. The method of claim 33, wherein the function change information indicates changing an entire specific function.

39. The method of claim 33, wherein the function change information indicates changing a portion of a specific function.

40. The method of claim 33, wherein the specific function is one of a language, a color and a font

41. The method of claim 40, wherein forming function change information comprises adding an index and a change variable, the index indicating a portion of a specific function and the change variable indicating a manner in which to change the portion of the specific function.

42. The method of claim 41, wherein the specific function is the language displayed by the display unit, the index indicates a displayed word and the change variable indicates a new language.

43. The method of claim 33, wherein the specific format is an SMI format.

44. The method of claim 33, wherein the control message is transmitted to a plurality of terminals.

45. A method for remote control of a terminal in a mobile communication system, the method comprising the steps of:
determining that a received message is a specific type;
determining that the received message contains function change information;
extracting function change information from the received message; and
changing a specific function of a terminal according to the function change information.

46. The method of claim 45, wherein the specific type is an LMS (Long Message Service) message.

47. The method of claim 45, wherein changing a specific function of a terminal comprises changing an entire specific function.

48. The method of claim 45, wherein changing a specific function of a terminal comprises changing a portion of a specific function.

49. The method of claim 45, further comprising the step of:
transmitting a function change request over a control channel to change a specific function of a terminal.

50. The method of claim 45, wherein the specific function is one of a displayed language, a stored language, a displayed color and a displayed font.

51. The method of claim 50, the function change information comprising an index and a change variable and wherein changing a specific function of a terminal comprises the steps of:
identifying a portion of a specific function corresponding to the index; and
changing the portion of the specific function in a manner based on the change variable.

52. The method of claim 50, the specific function is the displayed language, the index is a start position and the change variable is a new language, and wherein changing a specific function of a terminal comprises changing the language of displayed words corresponding to the start position to the new language.

53. The method of claim 45, wherein determining that the received message contains function change information comprises checking for an SMI format.
